(19) United States
(12) Patent Application Publication
(10) Pub. No.: US 2013/0088689 A1
(43) Pub. Date: Apr. 11, 2013

(54) LIGHT SOURCE MODULE AND PROJECTION APPARATUS

(71) Applicants: Hsin-Hung Lin, Hsinchu (TW); Yu-Yun Chang, Hsinchu (TW); Hung-Chih Chou, Hsinchu (TW); Haw-Woei Pan, Hsinchu (TW); Chao-Shun Chen, Hsinchu (TW)

(72) Inventors: Hsin-Hung Lin, Hsinchu (TW); Yu-Yun Chang, Hsinchu (TW); Hung-Chih Chou, Hsinchu (TW); Haw-Woei Pan, Hsinchu (TW); Chao-Shun Chen, Hsinchu (TW)

(73) Assignee: YOUNG OPTICS INC., Hsinchu (TW)

(21) Appl. No.: 13/267,897

(22) Filed: Oct. 7, 2011

(51) Int. Cl. G03B 21/14; F21V 9/00

(52) U.S. Cl. 353/31; 362/231

(57) ABSTRACT

A light source module including a first light-emitting device, a light emitting wheel, a second light-emitting device, and a light combination device is provided. The first light-emitting device provides an exciting beam. The light emitting wheel is disposed on a transmission path of the exciting beam and has a first light conversion area. The exciting beam obliquely irradiates on the first light conversion area and is converted into a first color beam. The second light-emitting device provides a second color beam. Herein, colors of the first color beam and the second color beam are different. The light combination device is disposed on the transmission paths of the first color beam and the second color beam. The first color beam is reflected to the light combination device by the light emitting wheel and the light combination device combines the first color beam and the second color beam.

### BACKGROUND OF THE INVENTION

1. Field of the Invention

The invention relates to a light source module and a projection apparatus. More particularly, the invention relates to a light source module and a projection apparatus having high brightness.

2. Description of Related Art

Currently, multimedia projectors usually use an ultra high pressure mercury lamp (UHP lamp) as a light source. The UHP lamp has advantages of high efficient and high luminance, which has good performance in the light flux of the projectors. However, the UHP lamp uses heavy metal mercury, so it is not an environment-friendly light source. Thus, with the increasing environmental awareness as well as the development of display technology, in recent years, a projector using red, green and blue light-emitting diodes (LEDs) as light sources is further developed.

Compared with the UHP lamps, the LED is much thinner and smaller, and the energy consumption of the LED is much lower. Besides, the LED has an advantage of high color saturation. Nevertheless, the luminance of the conventional projectors using LEDs as light sources is relatively low, which is not suitable to serve as a light source of a high brightness projector.

To achieve a high brightness projection effect, some optical elements, for example, dual light combination modules, dual lamps, or an LED array are used in the projector. However, a shift of a light spot occurs due to the dual light combination modules or the dual lamps of the projector are not disposed on an optical axis of the projector. Further, the luminance of the projector using dual light combination modules cannot be enhanced effectively. Similarly, since the LED array used in the projector is not disposed on an optical axis of the projector, the luminance of the projector cannot be improved effectively.

In addition, several patents related to a lighting apparatus are provided. For example, U.S. Pat. No. 7,547,114 and CN Patent No. 101498416 disclose a similar technique of using an exciting beam to irradiate on a wavelength-converting material so as to generate three color beams. U.S. Patent Publication No. 20090284148 discloses a technique of using an exciting beam to irradiate on a fluorescence layer on a transparent substrate so as to generate a beam with a predetermined waveband. Moreover, U.S. Patent Publication No. 20100328632 and 20100245776 disclose a technique of using a dichroic mirror located between a light emitting wheel and an exciting beam to change a transmission path of a color beam; however it increases the size of the optical system.

### SUMMARY OF THE INVENTION

The invention is directed to a light source module, which could provide a light source with relatively high brightness.

The invention provides a projection apparatus, which includes the aforementioned light source module.

Additional aspects and advantages of the invention will be set forth in the description of the techniques disclosed in the invention.

In order to achieve one or a part of or all of the above advantages or other advantages, an embodiment of the invention provides a light source module. The light source module includes a first light-emitting device, a light emitting wheel, a second light-emitting device, and a light combination device. The first light-emitting device provides an exciting beam. The light emitting wheel is disposed on a transmission path of the exciting beam and has a first light conversion area. The exciting beam obliquely irradiates onto the first light conversion area and is converted into a first color beam. The second light-emitting device provides a second color beam. Herein, colors of the first color beam and the second color beam are different. The light combination device is disposed on the transmission paths of the first color beam and the second color beam. The first color beam is reflected to the light combination device by the light emitting wheel and the light combination device combines the first color beam and the second color beam.

An embodiment of the invention also provides a projection apparatus including the aforementioned light source module, a light valve, and a projection lens. The light valve is disposed on the transmission paths of the first color beam and the second color beam, and coverts the first color beam and the second color beam into an image beam. The projection lens is disposed on a transmission path of the image beam, and projects the image beam to form an image on a screen.

An embodiment of the invention also provides another light source module. The light source module includes a first light-emitting device and a light emitting wheel. The first light-emitting device provides an exciting beam. The light emitting wheel is disposed on a transmission path of the exciting beam and has a first light conversion area and a second light conversion area. The exciting beam obliquely irradiating on the first light conversion area and the second light conversion area is respectively converted into a first color beam and a second color beam. Herein colors of the first color beam and the second color beam are different, and the first color beam and the second color beam are transmitted toward the same direction.

An embodiment of the invention also provides a projection apparatus including the aforementioned light source module, a light valve, and a projection lens. The light valve is disposed on the transmission paths of the first color beam and the second color beam, and coverts the first color beam and the second color beam into an image beam. The projection lens is disposed on a transmission path of the image beam, and projects the image beam to form an image on a screen.

According to the above descriptions, the embodiments of the invention have at least one of the following advantages or effects. In the embodiments of the invention, the light emitting wheel converts the first color beam through an exciting approach, so that the first color beam may have relatively strong intensity and the sizes of the light source module and the projection apparatus could be reduced. Besides, since the exciting beam obliquely irradiates on the first light conversion area, the interference between the exciting beam and the first color beam could be reduced.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram illustrating a projection apparatus according to a first embodiment of the invention.

FIG. 1B is a top view of a light emitting wheel of FIG. 1A.

FIG. 2A is a schematic diagram of a projection apparatus according to a second embodiment of the invention.

FIG. 2B is a top view of a light emitting wheel of FIG. 2A.

FIG. 2C is the cross-section of the light emitting wheel of FIG. 2A.

FIG. 2D is a cross-section of a light emitting wheel according to another embodiment of the invention.

FIG. 3A is a schematic diagram of a projection apparatus according to a third embodiment of the invention.

FIG. 3B is a top view of a light emitting wheel of FIG. 3A.

FIG. 4A is a schematic diagram of a projection apparatus according to a fourth embodiment of the invention.

FIG. 4B is a top view of a light emitting wheel of FIG. 4A.

FIG. 5A is a schematic diagram of a projection apparatus according to a fifth embodiment of the invention.

FIG. 5B is a top view of a light emitting wheel of FIG. 5A.

FIG. 6A is a schematic diagram of a projection apparatus according to a sixth embodiment of the invention.

FIG. 6B is a top view of a light emitting wheel of FIG. 6A.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising” or “having” and variations thereof herein is meant to encompass the items listed thereafter and equivalents thereof as well as additional items. Unless limited otherwise, the terms “connected”, “coupled” and “mounted” and variations thereof herein are used broadly and encompass direct and indirect connections, couplings, and mountings. Similarly, the terms “facing”, “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

### First Embodiment

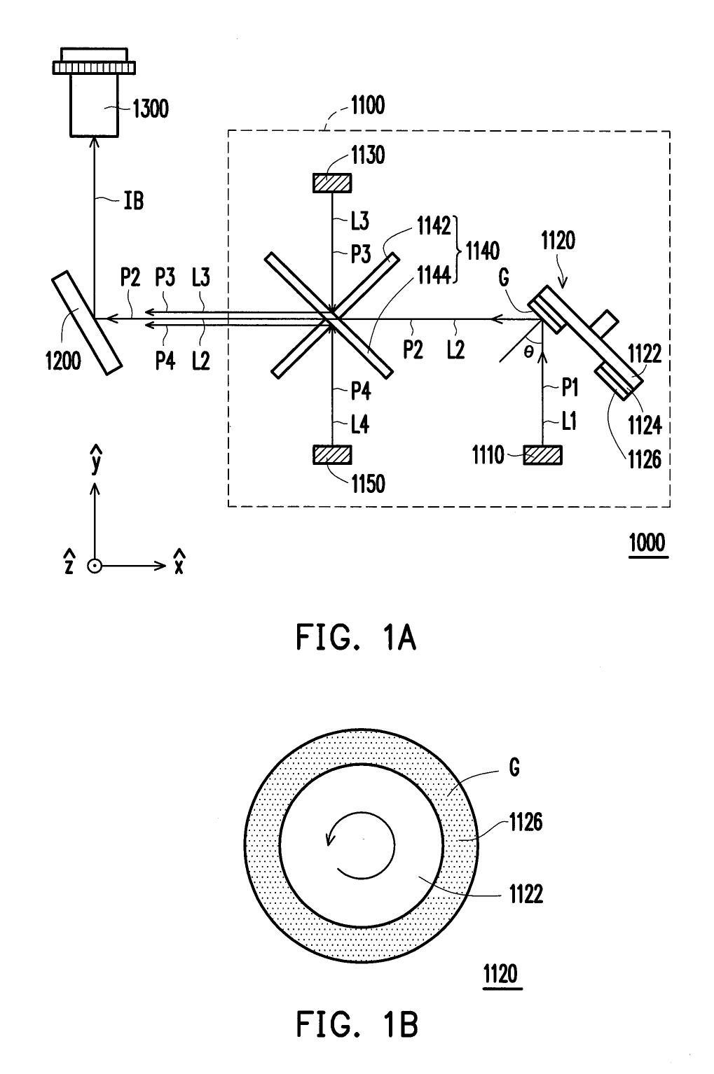

FIG. 1A is a schematic diagram illustrating a projection apparatus 1000 according to a first embodiment of the invention. FIG. 1B is a top view of a light emitting wheel 1120 of FIG. 1A. Referring to FIG. 1A, the projection apparatus 1000 of the embodiment includes a light source module 1100, a light valve 1200 and a projection lens 1300. The light source module 1100 includes a light-emitting device 1110, a light emitting wheel 1120, a light-emitting device 1130, and a light combination device 1140.

The light-emitting device 1110 provides an exciting beam L1. In the embodiment, the first light-emitting device 1110 is, for example, a blue solid-state laser or an ultraviolet (UV) laser, and a wavelength range of the exciting beam L1 is, for example, between 380 nm and 460 nm.

Referring to FIGS. 1A and 1B, the light emitting wheel 1120 is disposed on a transmission path P1 of the exciting beam L1 and has a light conversion area G. As shown in FIG. 1A, the exciting beam L1 obliquely irradiates on the light conversion area G and then the exciting beam L1 is converted into a color beam L2. In other words, an incident angle θ of the exciting beam L1 is greater than 0 degree, and the incident angle θ of the embodiment is, for example, 45 degrees. It should be noted that since the incident angle θ of the exciting beam L1 is greater than 0 degree, an interference between the exciting beam L1 and the color beam L2 could be reduced. Further, the light emitting wheel 1120 is suitable for rotating and may include a metal substrate 1122, a reflective layer 1124, and a fluorescence layer 1126. The fluorescence layer 1126 is disposed on the reflective layer 1124, and the fluorescence layer 1126 includes fluorescence powder coated on the reflective layer 1124. In the embodiment, the rotation of the light emitting wheel 1120 makes the exciting beam L1 obliquely irradiate on different positions of the light conversion area G at different time, and thereby it avails a heat dissipation effect of the projection apparatus 1000.

The light emitting wheel 1120 transmits the color beam L2 to the light combination device 1140. On the other hand, the color beam L2 of the embodiment is, for example, a green beam, and a wavelength range of the color barn L2 is between 520 nm and 540 nm As shown in FIG. 1A, when the exciting beam L1 irradiates onto the light emitting wheel 1120, fluorescence particles in the fluorescence layer 1126 are excited to release the color beam L2.

Referring to FIG. 1A, the light-emitting device 1130 emits another color beam L3, wherein colors of the color beam L2 and the color beam L3 are different. In the embodiment, colors of the color beam L2 and the color beam L3 are respectively green and red, and the light-emitting device 1130 is, for example, a light-emitting diode (LED). Moreover, the light combination device 1140 is disposed on the transmission paths P2 and P3 of the color beams L2 and L3. Herein, the color beam L2 is reflected to the light combination device 1140 by the reflective layer 1124 of the light emitting wheel 1120, and the light combination device 1140 combines the color beams L2 and L3. The light valve 1200 is disposed on the transmission paths P2 and P3 of the color beams L2 and L3, and converts the color beams L2 and L3 into an image beam IB. The image beam IB is projected by the projection lens 1300 to form an image on a screen. In the embodiment, the light valve 1200 is, for example, a digital micro-mirror device (DMD), a liquid-crystal-on-silicon panel (LCOS panel) or a liquid-crystal panel.

In the embodiment, the light combination device 1140 includes a dichroic units 1142 and 1144. The dichroic unit 1142 is disposed on the transmission paths P2 and P3 of the color beam L2 and the color beam L3. For example, the dichroic unit 1142 reflects the color beam L3, and transmits the color beam L2 to the light valve 1200, and then the dichroic unit 1142 combines the color beams L2 and L3. On the other hand, the dichroic unit 1144 of the light combination device 1140 is disposed on a transmission path P4 of a color beam L4 and the transmission paths P2 and P3 of the color beam L2 and the color beam L3. The dichroic unit 1144 reflects the color beam L4 and transmits the color beam L2 and the color beam L3, so as to combine the color beams L2, L3 and L4. Herein, the color beam L4 is, for example, a blue beam.

In the embodiment, the color beam L4 is provided by a light-emitting device 1150. In other words, the light source module 1100 further includes the light-emitting device 1150 which is, for example, an LED. Colors of the color beams L2, L3 and L4 are mutually different. In the embodiment, although the colors of the color beams L3 and L4 are respectively red and blue, in other embodiments, the colors of the color beam L3 and the color beam L4 may also be blue and red. Since the color beam L2 is converted from the exciting beam L1 through the light emitting wheel 1120, the projection apparatus 1000 with a simple configuration may provide a high brightness and good imaging performance.

### Second Embodiment

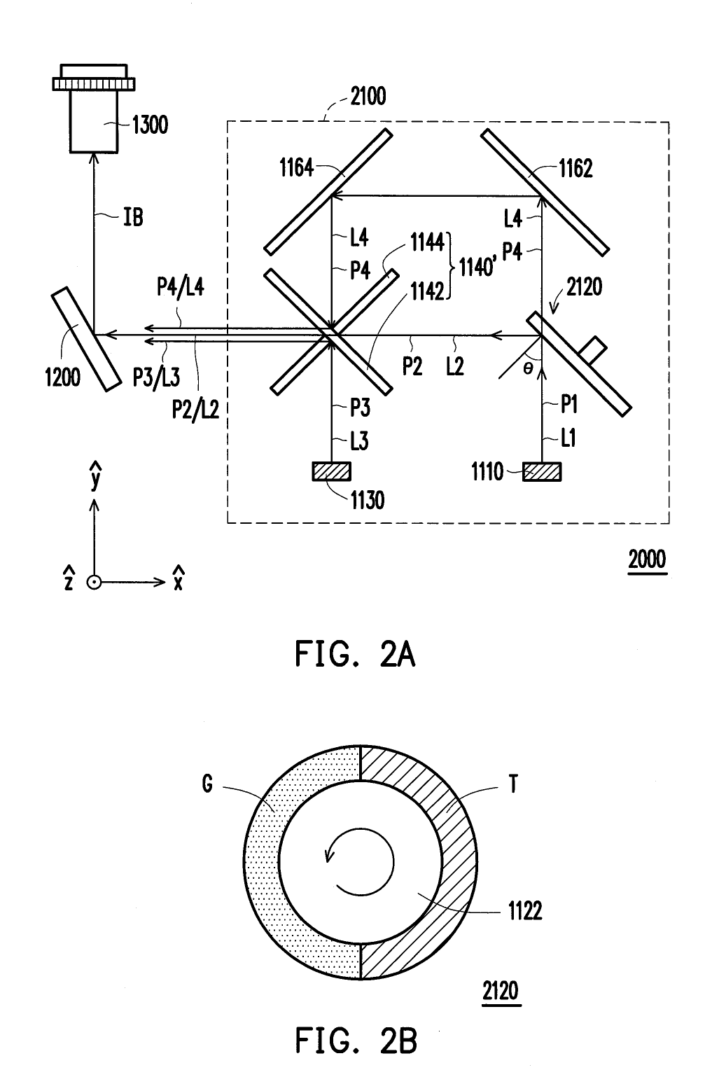

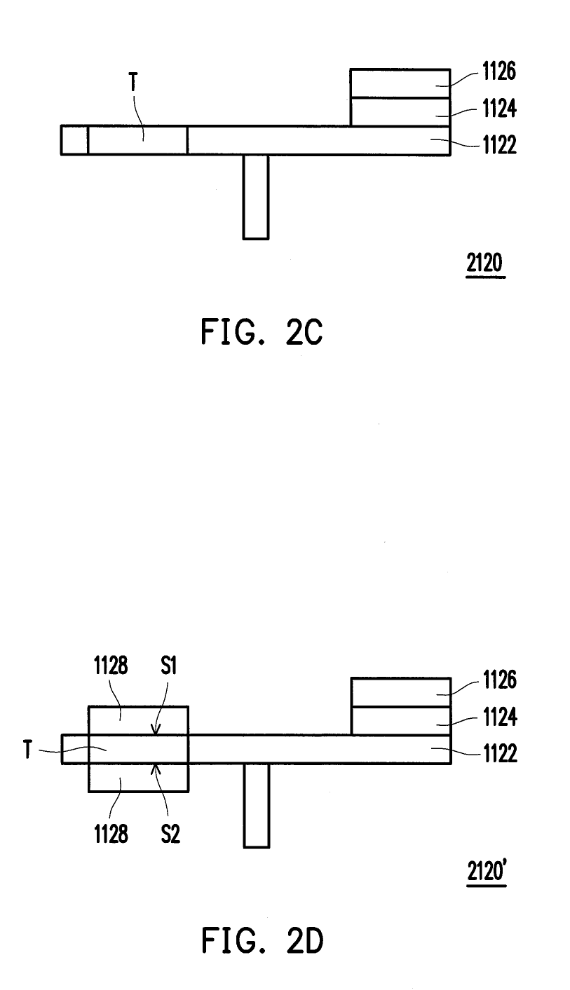

FIG. 2A is a schematic diagram of a projection apparatus 2000 according to a second embodiment of the invention. FIG. 2B is a top view of a light emitting wheel 2120 of FIG. 2A. FIG. 2C is the cross-section of the light emitting wheel 2120 of FIG. 2A. The projection apparatus 2000 of the embodiment is similar to the projection apparatus 1000 of FIG. 1A, while a main difference therebetween lies in the light emitting wheel 2120 further has a light-transmissive area T as shown in FIG. 2B and FIG. 2C. The light-transmissive area T transmits the exciting beam L1, and the exciting beam L1 passing through the light-transmissive area T is used as the color beam L4 of FIG. 1A. Specifically, the color beam L4 of FIG. 1A is provided by the light emitting diode 1150, while the color beam L4 of FIG. 2A is from the exciting beam L1. In the embodiment, the exciting beam L1 is, for example, a blue laser, and the color beam L4 is a blue beam.

As shown in FIG. 2C, the light emitting wheel 2120 has the light-transmissive area T and includes the metal substrate 1122, the reflective layer 1124, and the fluorescence layer 1126. The fluorescence layer 1126 is disposed on the reflective layer 1124, and the fluorescence layer 1126 includes fluorescence powder coated on the reflective layer 1124.

Referring to FIG. 2A again, the projection apparatus 2000 further includes a first reflective unit 1162 and a second reflective unit 1164. The first reflective unit 1162 is disposed on the transmission path P4 of the color beam L4, and reflects the color beam L4 passing through the light-transmissive area T of the light emitting wheel 2120. The second reflective unit 1164 is disposed opposite to the first reflective unit 1162, and reflects the color beam L4 from the first reflective unit 1162 to the light combination device 1140′. The dichroic unit 1144 of the light combination device 1140′ reflects the color beam L4 and transmits the color beams L2 and L3. The color beams L2 and L3 are respectively a green beam and a red beam, for example. On the other hand, the dichroic unit 1142 reflects the color beam L3 from the light-emitting device 1130 and transmits the color beams L2 and L4.

The dichroic units 1142 and 1144 of the light combination device 1140′ combine the color beams L2, L3 and L4. Since the color beam L2 is converted from the exciting beam L1 through the light emitting wheel 2120, the projection apparatus 2000 with a simple configuration could provide a high brightness and good imaging performance.

FIG. 2D is a cross-section of a light emitting wheel 2120′ according to another embodiment. As shown in FIG. 2D, in another embodiment, the light emitting wheel 2120′ may include a diffuser 1128. The diffuser 1128 is disposed on at least one surface (e.g. surface S1 or S2) of the light-transmissive area T for reducing a laser speckle, while the invention is not limited thereto.

### Third Embodiment

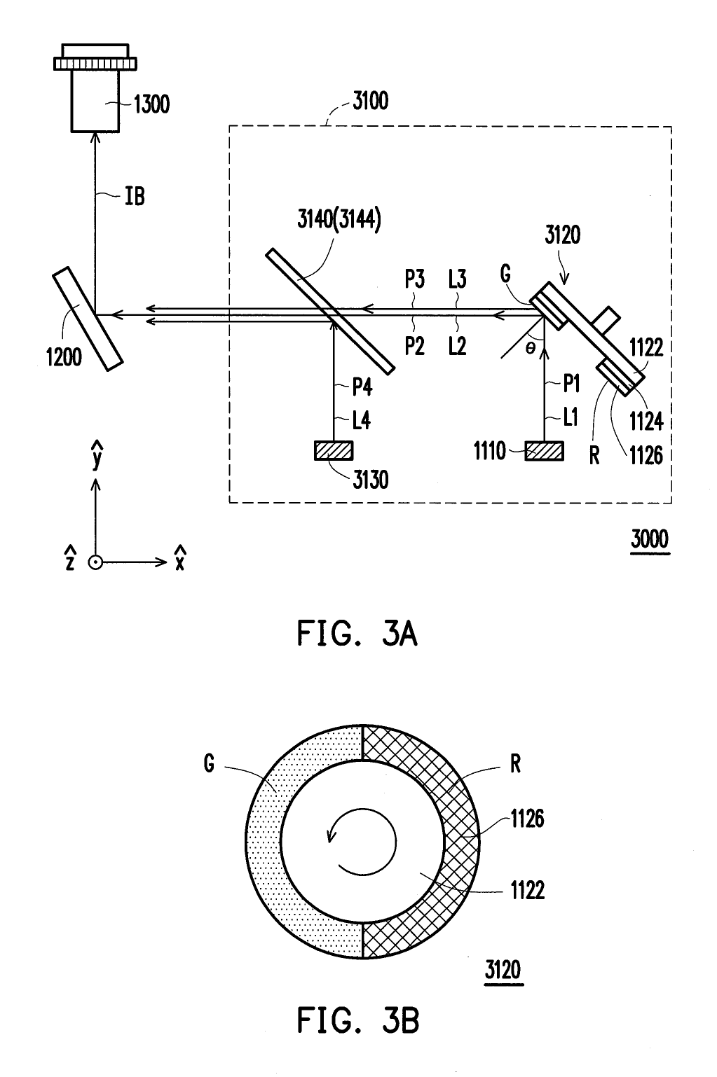

FIG. 3A is a schematic diagram of a projection apparatus 3000 according to a third embodiment of the invention. FIG. 3B is a top view of a light emitting wheel 3120 of FIG. 3A. The projection apparatus 3000 of the embodiment is similar to the projection apparatus 1000 of FIG. 1A, while a main difference therebetween lies in the light emitting wheel 3120 further has a light conversion area R as shown in FIG. 3B. Referring to FIG. 3A, a light source module 3100 of the projection apparatus 3000 includes the light-emitting device 1110, a light emitting wheel 3120 and a light-emitting device 3130. Herein, the light emitting wheel 3120 has the light conversion area G and the light conversion area R as shown in FIG. 3B. The fluorescence layers 1126 of the light conversion areas G and R are respectively a green fluorescence layer and a red fluorescence layer, for example. The exciting beam L1 obliquely irradiates on the light conversion area G and is converted into the color beam L2 with green color. Besides, the exciting beam L1 obliquely irradiates on the light conversion area R and is converted into the color beam L3 with red color. The light-emitting device 3130 provides the color beam L4 which is a blue beam, for example.

Referring to FIG. 3A, a light combination device 3140 of the light source module 3100 includes a dichroic unit 3144 which is disposed on the transmission paths P2, P3 and P4 of the color beams L2, L3 and L4. Herein, the dichroic unit 3144 reflects the color beam L4, and transmits the color beams L2 and L3, and the dichroic unit 3144 combines the color beams L2, L3 and L4. Since the color beams L2 and L3 are converted from the exciting beam L1 through the light emitting wheel 3120, the projection apparatus 3000 with a simple configuration could provide a high brightness and good imaging performance.

### Fourth Embodiment

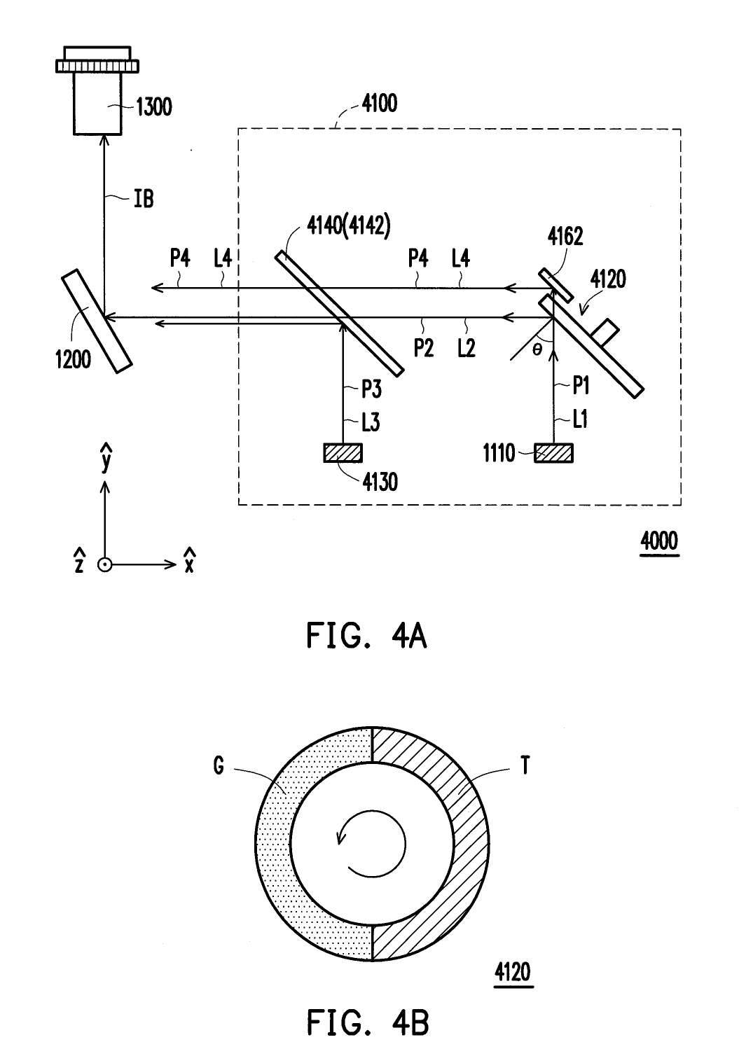

FIG. 4A is a schematic diagram of a projection apparatus 4000 according to a fourth embodiment of the invention. FIG. 4B is a top view of a light emitting wheel 4120 of FIG. 4A. Referring to FIG. 4A, the light source module 4100 of the projection apparatus 4000 includes the light-emitting device 1110, the light emitting wheel 4120 and a light-emitting device 4130. As shown in FIG. 4B, the light emitting wheel 4120 of the embodiment has the light conversion area G and the light-transmissive area T. In the embodiment, a cross-section of the light emitting wheel 4120 is similar to FIG. 2C or 2D, and thus a detailed description thereof is omitted hereinafter.

Referring to FIG. 4A, the exciting beam L1 provided by the light-emitting device 1110 obliquely irradiates on the light conversion area G and is converted into the color beam L2 with green color. Besides, the light-transmissive area T of FIG. 4B transmits the exciting beam L1 which is a blue laser, for example. On the other hand, the exciting beam L1 passing through the light-transmissive area T is used as another color beam L4 which is a blue beam. Besides, the light-emitting device 4130 provides the color beam L3 with red color.

As shown in FIG. 4A, the light combination device 4140 of the light source module 4100 includes a dichroic unit 4142 which is disposed on the transmission paths P2, P3 and P4 of the color beams L2, L3 and L4, wherein the dichroic unit 4142 reflects the color beam L3, and transmits the color beam L2 and the color beam L4, and the dichroic unit 4142 combines the color beams L2, L3 and L4. Moreover, the light source module 4100 of the embodiment further includes a reflective unit 4162 disposed between the light emitting wheel 4120 and the dichroic unit 4142. The reflective unit 4162 reflects the color beam L4 passing through the light emitting wheel 4120 toward the dichroic unit 4142. Since the color beam L2 is converted from the exciting beam L1 through the light emitting wheel 4120, the projection apparatus 4000 with a simple configuration could provide a high brightness and good imaging performance.

### Fifth Embodiment

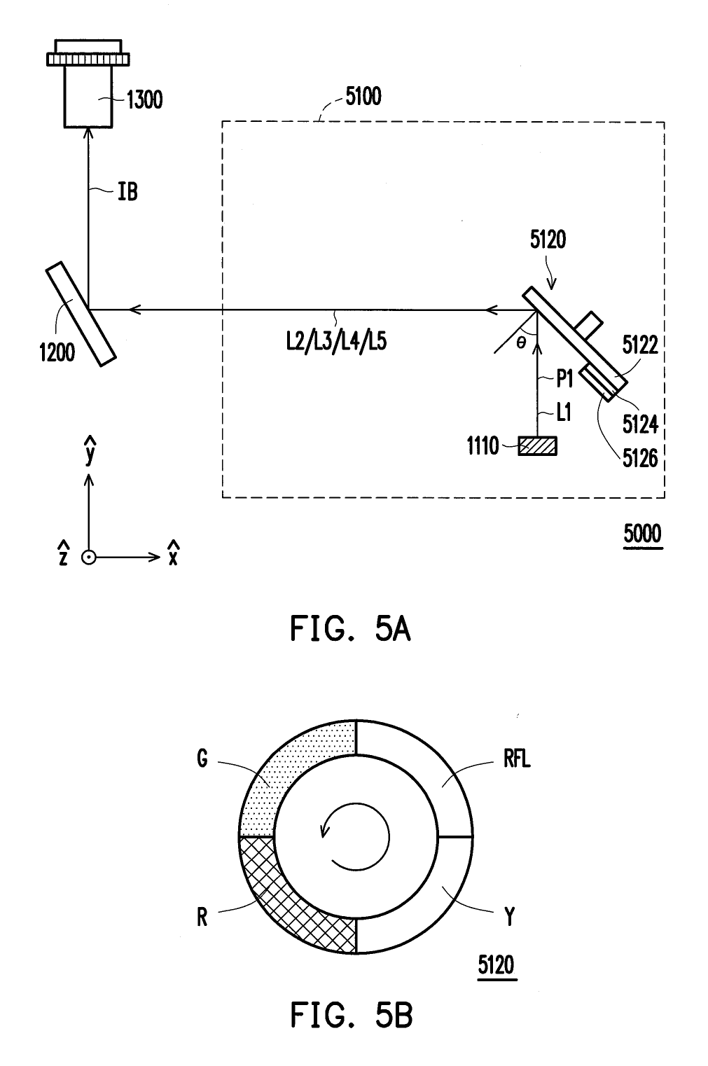

FIG. 5A is a schematic diagram of a projection apparatus 5000 according to a fifth embodiment of the invention. FIG. 5B is a top view of a light emitting wheel 5120 of FIG. 5A. Referring to FIG. 5A, the projection apparatus 5000 of the embodiment includes a light source module 5100, the light valve 1200, and the projection lens 1300. The light source module 5100 includes the light-emitting device 1110 and the light emitting wheel 5120.

Referring to FIGS. 5A and 5B, the light-emitting device 1110 provides the exciting beam L1. The light emitting wheel 5120 is disposed on the transmission path P1 of the exciting beam L1 and has the light conversion areas G and R. The light emitting wheel 5120 is suitable for rotating, and the exciting beam L1 obliquely irradiating on the light conversion areas G and R are respectively converted into the color beams L2 and L3. Colors of the color beam L2 and the color beam L3 are different, and the color beam L2 and the color beam L3 are transmitted toward the same direction. In the embodiment, the color beams L2 and L3 are respectively a green beam and a red beam, for example. Each of the light conversion areas G and R includes a reflective layer 5124 and a fluorescence layer 5126. The reflective layer 5124 is disposed on a metal substrate 5122, and the fluorescence layer 5126 is disposed on the reflective layer 5124. The light emitting wheel 5120 transmits the color beams L2 and L3 to the light valve 1200.

Moreover, the light emitting wheel 5120 of the embodiment further has a reflective area RFL reflecting the exciting beam L1 obliquely irradiated on the reflective area RFL to the light valve 1200. The reflective area RFL is, for example, a reflective mirror, and the exciting beam L1 reflected by the reflective area RFL is used as another color beam L4 which is a blue beam, for example. In other words, colors of the color beams L2, L3 and L4 are mutually different. Besides, the color beams L2, L3 and L4 are transmitted toward the same direction. Specifically, the color beams L2, L3 and L4 are transmitted toward the light valve 1200, and the light valve 1200 coverts the color beams L2, L3 and L4 into the image beam IB and then transmitted to the projection lens 1300.

Besides, the light emitting wheel 5120 of the embodiment further has a light conversion area Y. When the exciting beam L1 irradiates on the light conversion area Y, the exciting beam L1 is converted into a color beam L5. In the embodiment, the color beam L5 is, for example, a yellow beam which can enhance the brightness of the projection apparatus 5000. However, in another embodiment, the light emitting wheel 5120 may not have the light conversion area Y, and the invention is not limited to FIG. 5B. It should be noted that since the color beams L2, L3 and L5 are converted from the exciting beam L1 through the light emitting wheel 5120 and the color beam L4 is generated from the exciting beam L1 reflected by the light emitting wheel 5120, there is no need to use a dichroic unit or a reflective mirror to guide the color beams L2˜L5 toward the light valve 1200. Thus, the size of projection apparatus 5000 may be reduced and the projection apparatus 5000 with a simple configuration could provide a high brightness and good imaging performance.

### Sixth Embodiment

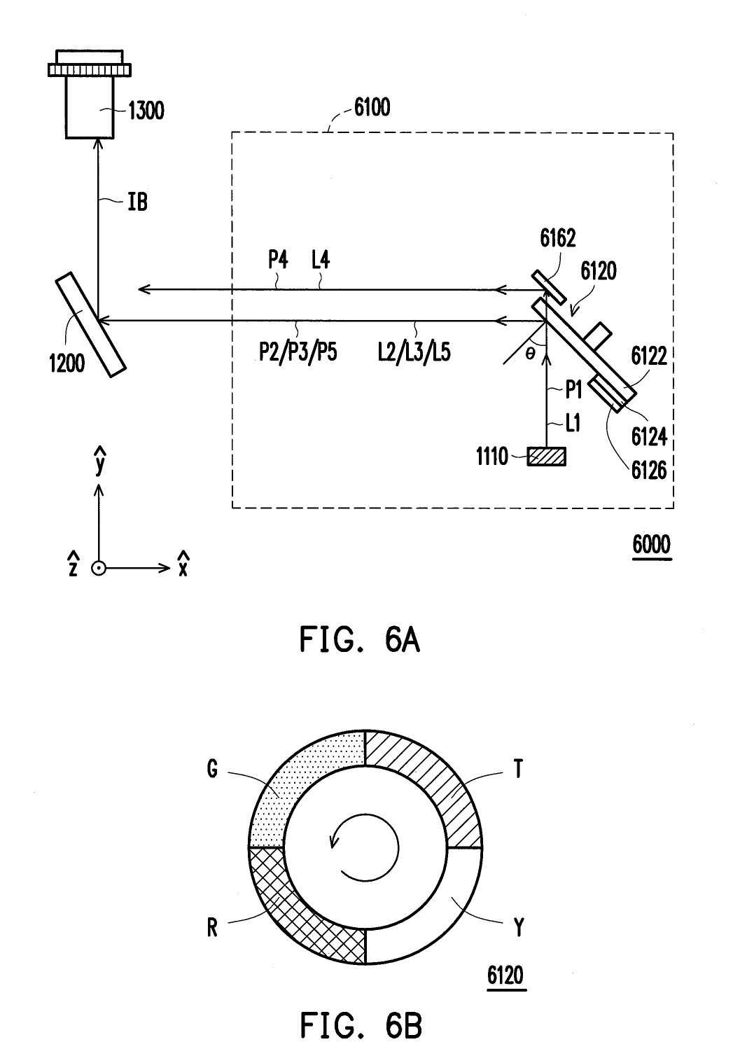

FIG. 6A is a schematic diagram of a projection apparatus 6000 according to a sixth embodiment of the invention. FIG. 6B is a top view of a light emitting wheel 6120 of FIG. 6A. The projection apparatus 6000 of the embodiment is similar to the projection apparatus 5000 of FIG. 5A, while a main difference therebetween lies in the light emitting wheel 6120 further has the light-transmissive area T and does not have the reflective area RFL of FIG. 5B.

Referring to FIG. 6A, the projection apparatus 6000 of the embodiment includes a light source module 6100, the light valve 1200, and the projection lens 1300. The light source module 6100 includes the light-emitting device 1110, the light emitting wheel 6120, and a reflective unit 6162. Specifically, the light-transmissive area T of the light emitting wheel 6120 transmits the exciting beam L1, and the exciting beam L1 passing through the light-transmissive area T is used as the color beam L4 which has a color (e.g. blue) different from the colors of the color beam L2 and the color beam L3. The color beams L2, L3 and L4 are transmitted toward the same direction. For example, the color beams L2, L3 and L4 are transmitted toward the light valve 1200, and the light valve 1200 coverts the color beams L2, L3 and L4 into the image beam IB and then transmitted to the projection lens 1300.

Similarly, the light emitting wheel 6120 of the embodiment further has a light conversion area Y. When the exciting beam L1 irradiates on the light conversion area Y, the exciting beam L1 is converted into a color beam L5. In the embodiment, the color beam L5 is, for example, a yellow beam which can enhance the brightness of the projection apparatus 6000.

Furthermore, as shown in FIG. 6A, each of the light conversion area G, R and Y includes a reflective layer 6124 and a fluorescence layer 6126. The reflective layer 6124 is disposed on a metal substrate 6122, and the fluorescence layer 6126 is disposed on the reflective layer 6124. Besides, the light emitting wheel 6120 may include the diffuser 1128 disposed on at least one surface S1 or S2 of the light-transmissive area T as shown in FIG. 2D. Since the cross-section of the light-transmissive area T of the embodiment can be referred to FIG. 2D, a detailed description thereof is not repeated. It should be noted that since the color beams L2, L3 and L5 are converted from the exciting beam L1 through the light emitting wheel 6120, there is no need to use a dichroic unit or another reflective mirror to guide the color beams L2, L3 and L5 toward the light valve 1200. Thus, the size of projection apparatus 6000 could be reduced and the projection apparatus 6000 with a simple configuration could provide a high brightness and good imaging performance.

In summary, the embodiments of the invention have at least one of the following advantages or effects. In the embodiments of the invention, the light emitting wheel converts the first color beam through an exciting approach, so that the first color beam may have relatively strong intensity and the sizes of the light source module and the projection apparatus could be reduced. Besides, since the exciting beam obliquely irradiates on the first light conversion area, the interference between the exciting beam and the first color beam could be reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims. In addition, the first reflective unit, the second reflective unit, . . . , mentioned in the specification are used to represent the terminologies of the components/devices, and not used to limit the upper or lower bound of the number of the components/devices.

What is claimed is:

1. A light source module, comprising:
a first light-emitting device, providing an exciting beam;
a light emitting wheel, disposed on a transmission path of the exciting beam and having a first light conversion area, wherein the exciting beam obliquely irradiates on the first light conversion area and is converted into a first color beam;
a second light-emitting device, providing a second color beam, wherein colors of the first color beam and the second color beam are different; and
a light combination device, disposed on the transmission paths of the first color beam and the second color beam, wherein the first color beam is reflected to the light combination device by the light emitting wheel and the light combination device combines the first color beam and the second color beam.

2. The light source module as claimed in claim 1, wherein the light combination device comprises:
a first dichroic unit, disposed on the transmission paths of the first color beam and the second color beam, wherein the first dichroic unit reflects the second color beam, and transmits the first color beam, and the first dichroic unit combines the first color beam and the second color beam; and
a second dichroic unit, disposed on a transmission path of a third color beam and the transmission paths of the first color beam and the second color beam, wherein the second dichroic unit reflects the third color beam and transmits the first color beam and the second color beam, so as to combine the first color beam, the second color beam and the third color beam.

3. The light source module as claimed in claim 2, further comprising a third light-emitting device to provide the third color beam and colors of the third color beam, the first color beam and the second color beam are mutually different.

4. The light source module as claimed in claim 2, wherein the light emitting wheel further has a light-transmissive area transmitting the exciting beam, and the exciting beam passing through the light-transmissive area is used as the third color beam.

5. The light source module as claimed in claim 4, wherein the light emitting wheel comprises a diffuser disposed on at least one surface of the light-transmissive area.

6. The light source module as claimed in claim 4, further comprising:
a first reflective unit, disposed on the transmission path of the third color beam and reflecting the third color beam passing through the light emitting wheel; and
a second reflective unit, disposed opposite to the first reflective unit, and reflecting the third color beam from the first reflective unit to the light combination device.

7. The light source module as claimed in claim 1, wherein the light emitting wheel further has a second light conversion area converting the exciting beam obliquely irradiating on the second light conversion area into a third color beam, and colors of the third color beam, the first color beam and the second color beam are mutually different.

8. The light source module as claimed in claim 7, wherein the light combination device comprises:
a dichroic unit, disposed on the transmission paths of the first color beam, the second color beam and the third color beam, wherein the dichroic unit reflects the second color beam, and transmits the first color beam and the third color beam, and the dichroic unit combines the first color beam, the second color beam, and the third color beam.

9. The light source module as claimed in claim 1, wherein the light emitting wheel further has a light-transmissive area transmitting the exciting beam, and the exciting beam passing through the light-transmissive area is used as a third color beam, and colors of the third color beam, the first color beam and the second color beam are mutually different.

10. The light source module as claimed in claim 9, wherein the light combination device comprises:
a dichroic unit, disposed on the transmission paths of the first color beam, the second color beam, and the third color beam, wherein the dichroic unit reflects the second color beam and transmits the first color beam and the third color beam, and the dichroic unit combines the first color beam, the second color beam, and the third color beam.

11. The light source module as claimed in claim 10, further comprising:
a reflective unit, disposed between the light emitting wheel and the dichroic unit and reflecting the third color beam passing through the light emitting wheel toward the dichroic unit.

12. The light source module as claimed in claim 9, further comprising a diffuser disposed on at least one surface of the light-transmissive area.

13. The light source module as claimed in claim 1, wherein the first light conversion area of the light emitting wheel comprises:
a reflective layer; and
a fluorescence layer, disposed on the reflective layer, wherein the light emitting wheel transmits the first color beam to the light combination device.

14. A light source module, comprising:
a first light-emitting device, providing an exciting beam; and
a light emitting wheel, disposed on a transmission path of the exciting beam and having a first light conversion area and a second light conversion area, wherein the exciting beam obliquely irradiating on the first light conversion area and the second light conversion area is respectively converted into a first color beam and a second color beam, wherein colors of the first color beam and the second color beam are different, and the first color beam and the second color beam are transmitted toward the same direction;
wherein each of the first light conversion area and the second light conversion area comprises:
a reflective layer; and
a fluorescence layer, disposed on the reflective layer.

15. The light source module as claimed in claim 14, wherein the light emitting wheel further has a reflective area reflecting the exciting beam obliquely irradiating on the reflective area, and the exciting beam reflected by the reflective area is used as a third color beam, wherein colors of the first color beam, the second color beam and the third color beam are different, and the first color beam, the second color beam and the third color beam are transmitted toward the same direction.

16. The light source module as claimed in claim 14, wherein the light emitting wheel further has a light-transmissive area transmitting the exciting beam, and the exciting beam passing through the light-transmissive area is used as a third color beam having a color different from the colors of the first color beam and the second color beam, and the first color beam, the second color beam and the third color beam are transmitted toward the same direction.

17. The light source module as claimed in claim 16, further comprising a reflective unit disposed on the transmission path of the exiting beam, wherein the light emitting wheel is disposed between the reflective unit and the first light-emitting device, and the reflective unit reflects the third color beam to make the first color beam, the second color beam and the third color beam be transmitted toward the same direction.

18. The light source module as claimed in claim 16, wherein the light emitting wheel comprises a diffuser disposed on at least one surface of the light-transmissive area.

19. A projection apparatus, comprising:
a light source module, comprising:
a first light-emitting device, providing an exciting beam;
a light emitting wheel, disposed on a transmission path of the exciting beam and having a first light conversion area, wherein the exciting beam obliquely irradiates on the first light conversion area and is converted into a first color beam;
a second light-emitting device, providing a second color beam, wherein colors of the first color beam and the second color beam are different; and
a light combination device, disposed on the transmission paths of the first color beam and the second color beam, wherein the first color beam is reflected to the light combination device by the light emitting wheel and the light combination device combines the first color beam and the second color beam;
a light valve, disposed on the transmission paths of the first color beam and the second color beam, and converting the first color beam and the second color beam into an image beam; and
a projection lens, disposed on a transmission path of the image beam, and projecting the image beam to form an image.

20. A projection apparatus, comprising:
a light source module, comprising:
a first light-emitting device, providing an exciting beam; and
a light emitting wheel, disposed on a transmission path of the exciting beam and having a first light conversion area and a second light conversion area, wherein the exciting beam obliquely irradiating on the first light conversion area and the second light conversion area is respectively converted into a first color beam and a second color beam, wherein colors of the first color beam and the second color beam are different, and the first color beam and the second color beam are transmitted toward the same direction;
a light valve, disposed on the transmission paths of the first color beam and the second color beam, and converting the first color beam and the second color beam into an image beam; and
a projection lens, disposed on a transmission path of the image beam, and projecting the image beam to form an image.
